(19) United States
(12) Patent Application Publication
(10) Pub. No.: US 2025/0181135 A1
(43) Pub. Date: Jun. 5, 2025

(54) PERIPHERAL INPUT DEVICES INCLUDING USER PRESENCE DETECTION SENSORS AND RELATED METHODS

(71) Applicant: Intel Corporation, Santa Clara, CA (US)

(72) Inventors: Jian LIU, Shanghai (CN); Ke HAN, Shanghai (CN); Zhen LI, Shanghai (CN)

(21) Appl. No.: 18/842,342

(22) PCT Filed: Apr. 1, 2022
(86) PCT No.: PCT/CN2022/084726

§ 371 Date: Aug. 28, 2024

(51) Int. Cl. G06F 1/3231; G06F 1/3287; G06F 3/0354

(52) U.S. Cl. CPC G06F 1/3231; G06F 1/3287; G06F 3/03543

(57) ABSTRACT

Peripheral input devices including user presence detection sensors and related methods are disclosed herein. An example apparatus includes processor circuitry to execute instructions to cause a user device to transition from a first device state to a second device state in response to an indication of a first user presence state at a first time, the first user presence state relative to a peripheral input device communicatively coupled to the user device; cause the user device to transition from the second device state to a third device state in response to an indication of a second user presence state relative to the peripheral input device at a second time; and cause the user device to transition from the third device state to the first device state in response to an indication of the second user presence state relative to the peripheral input device at a third time.

### FIELD OF THE DISCLOSURE

This disclosure relates generally to electronic user devices and, more particularly, to peripheral input devices including user presence detection sensors and related methods.

### BACKGROUND

An electronic user device, such as a laptop or desktop, can enter a low power state or standby mode when the device is powered on but has not received a user input for an extended amount of time. An action by the user such as pressing a key on a keyboard or moving an input device such as a mouse or touch pad can prompt the device to wake and move from the low power state to a working operational state.

### BRIEF DESCRIPTION OF THE DRAWINGS

FIG. 1 illustrates an example system constructed in accordance teachings of this disclosure and including an example user device, an example peripheral input device, example subject detection circuitry, and example device control circuitry for controlling a device state of the user device.

FIG. 2 is a block diagram of the example subject detection circuitry of FIG. 1.

FIG. 3 is a block diagram of the example device control circuitry of FIG. 1.

FIG. 4 is a flowchart representative of example machine readable instructions and/or example operations that may be executed by example processor circuitry to implement the example subject detection circuitry of FIG. 2.

FIG. 5 is a flowchart representative of example machine readable instructions and/or example operations that may be executed by example processor circuitry to implement the example device control circuitry of FIG. 2.

FIG. 6 is a block diagram of an example processing platform including processor circuitry structured to execute the example machine readable instructions and/or the example operations of FIG. 4 to implement the subject detection circuitry of FIG. 2.

FIG. 7 is a block diagram of an example processing platform including processor circuitry structured to execute the example machine readable instructions and/or the example operations of FIG. 5 to implement the device control circuitry of FIG. 3.

FIG. 8 is a block diagram of an example implementation of the processor circuitry of FIGS. 6 and/or 7

FIG. 9 is a block diagram of another example implementation of the processor circuitry of FIGS. 6 and/or 7.

FIG. 10 is a block diagram of an example software distribution platform (e.g., one or more servers) to distribute software (e.g., software corresponding to the example machine readable instructions of FIGS. 5 and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

An electronic user device such as a laptop, a tablet, etc. can transition between different system power states. When the user device is in use by the user, the device is in the working system power state, also known as an S0 system power state. The user device is fully operational in the S0 system power state in that the display screen is turned on, applications are being executed by processor(s) of the device, etc. The user device consumes the highest amount of power in the S0 system power state.

The user device can enter a lower power state when the device is powered on but has not received a user input for an extended period of time in an effort to reduce power consumption. This may be when the device is not being actively used by a user. Some user devices transition to a connected standby mode, also referred to as an S0 low-power idle state, after a period of time in which no user inputs have been received at the device. In the connected standby mode, the display screen of the device is turned off, certain components of the user device may be partly or completely powered down, and/or certain applications may not be executed by processor(s) of the device. However, the device remains connected to the Internet via one or more wired or wireless connection(s) such that processor(s) of the device can respond quickly to hardware and/or network events. For instance, in the connected standby mode, an email application downloads emails, rather than waiting to refresh emails when the device returns to the working system power state (S0).

Devices that support the connected standby mode are also quickly able to return to the working system power state (S0) based on a user input such as dragging a finger across a touch pad or isopoint device and/or touching a touch-enabled screen of the device. In some instances, the user input is provided via a peripheral input device, such as pressing a key on a wired or wireless keyboard and/or moving a mouse. In response to such a wake event, pixels are turned on and/or a resolution or a brightness of the display screen is adjusted to present content and enable the user to interact with the device.

Disclosed herein are example peripheral input devices (e.g., a mouse, a keyboard, a webcam) including user presence detection sensors (e.g., time-of-flight sensors) to detect a presence of a user relative to the peripheral input device. Examples disclosed herein include subject detection circuitry to output reports indicating a user presence state (e.g., a present state, absent state) relative to the peripheral user device. In examples disclosed herein, the user presence state is used to control a device state (e.g., a power state, lock state) of a user device in communication with the peripheral input device. In response to an indication that the user presence state relative to the peripheral device is a present state (i.e., a user is detected within the range of the sensors carried by the peripheral input device), examples disclosed herein can cause the user device to transition from the connected standby mode (S0 low-power idle state) to the working system power state (S0). Thus, examples disclosed herein can wake the device without physical contact with the user device and/or at the peripheral input device (e.g., without moving the mouse).

Examples disclosed herein monitor the user presence state over time to verify that the user is still proximate to the peripheral input device. Examples disclosed herein maintain the user device in the working system power state (S0) even if a user input has not been received at the user device within a threshold period of time if the analysis of the sensor data generated by the user presence detection sensors indicates that the user is proximate to the peripheral input device. Thus, examples disclosed herein prevent the user device from automatically locking or moving to a low power state when, for instance, the user is watching a video on the display screen of the user device but not actively providing user inputs at the device.

Examples disclosed herein respond to the changes in the user presence state such as when a user walks away from the peripheral user device and, thus, is outside the range of the user presence detection sensors of the associated peripheral input device. In response to determining that the user is no longer proximate to the peripheral input device, examples disclosed herein adjust one or more states of the user device. For example, in response to determining that the user presence state is the absent state at a first time, examples disclosed herein can instruct the operating system to move the device to a locked state such that a user provides identifying information (e.g., a password) to (re-) access applications on the device. In response to determining that the user presence state continues to be the absent state for a threshold duration of time, examples disclosed herein can cause the user device to move to the connected standby mode to conserve power when the user is not detected in the proximity of the associated peripheral input device.

Although examples disclosed herein are discussed in connection with the connected standby mode (S0 low-power idle state), examples disclosed herein can be implemented in connection with other known standby/sleep power states or future standby/sleep power states providing for always-on internet protocol functionality.

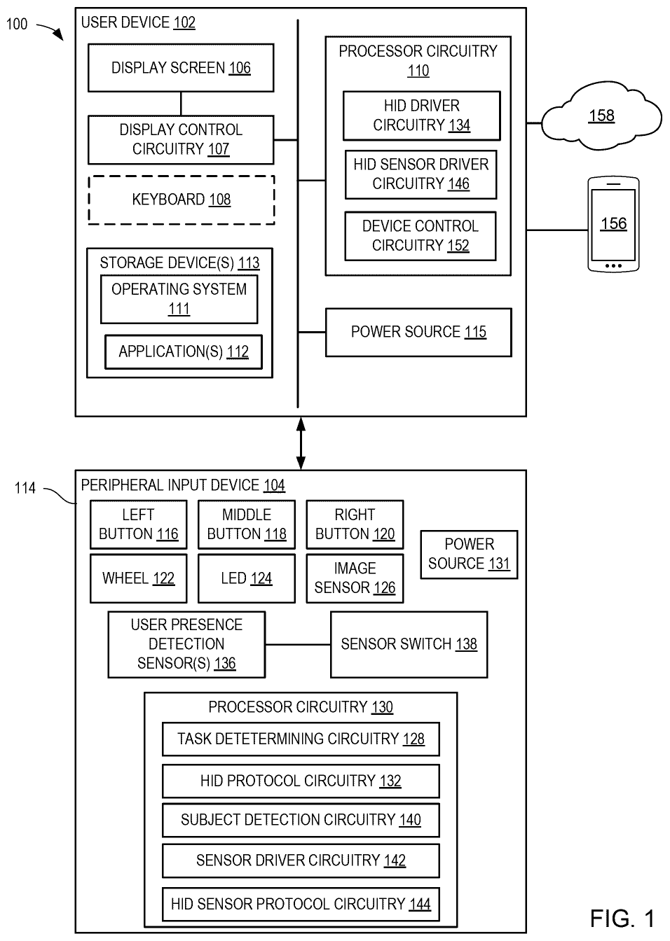

FIG. 1 illustrates an example system 100 including a user device 102 and a peripheral input device 104 for providing user inputs to the user device 102 in accordance with teachings of this disclosure. The user device 102 can include a personal computing (PC) device such as a laptop, a desktop, an all-in-one PC, etc. In the example of FIG. 1, the peripheral input device 104 is a mouse. However, the peripheral input device 104 can include other types of peripheral input devices that can be communicatively coupled to the user device 102, such as a keyboard, trackpad, speakers, secondary displays, external hard drives, a webcam, etc. For purposes of this disclosure, the peripheral input device 104 will sometimes be referred to herein as the mouse 104 with the understanding that the peripheral input device 104 can include other types of peripheral input devices.

The example user device 102 includes a display screen 106 and display control circuitry 107 to cause graphical content (e.g., graphical user interfaces(s)) to be presented via the display screen 106. In some examples, the user device 102 includes a keyboard 108 (e.g., a laptop keyboard). In other examples, the keyboard 108 is a peripheral input device communicatively coupled to the user device 102 via one or more wired or wireless communication protocols (e.g., the peripheral input device 104, another peripheral input device communicatively coupled to the user device 102).

The user device 102 of FIG. 1 includes processor circuitry 110. The processor circuitry 110 executes machine readable instructions (e.g., software) including, for example, an operating system 111 and/or other user application(s) 112 installed on the user device 102, to interpret and output response(s) based on the user input event(s) (e.g., mouse input(s), keyboard input(s), touch event(s), etc.) provided by a user (the terms “user” and “subject” are used interchangeably herein and both refer to a human being). The operating system 111 and the user application(s) 112 are stored in one or more storage devices 113. The user device 102 of FIG. 1 includes a power source 115 such as a battery to provide power to the processor circuitry 110 and/or other components of the user device 102.

Referring now to the example peripheral input device 104 of FIG. 1, the peripheral input device or mouse 104 includes a housing 114. The housing 114 supports a left button 116, a middle button 118, a right button 120, and a wheel 122. A user of the mouse 104 can provide inputs to the user device 102 via one or more of the buttons 116, 118, 120 (e.g., via clicking) and/or the wheel 122 (e.g., via scrolling). The mouse 104 can include additional or fewer buttons, wheels, etc. than shown in FIG. 1.

The housing 114 of the peripheral input device 104 of FIG. 1 supports electronic components of the mouse 104. For example, the peripheral input device 104 can be an optical mouse including a light emitting diode (LED) 124 to emit light that bounces off a surface and is detected by an image sensor 126 (e.g., a complementary metal oxide semiconductor image sensor) of the mouse 104. The example mouse 104 includes task determining circuitry 128 to analyze images generated by the image sensor 126 and to detect movement of the mouse 104. The task determining circuitry 128 determines coordinates of the mouse 104 based on the image analysis. The task determining circuitry 128 can be implemented by processor circuitry 130 of the mouse 104. The example peripheral input device 104 includes a power source 131 such as a battery to provide power to the processor circuitry 130 and/or other components of the peripheral input device 104.

In the example of FIG. 1, the user device 102 and the peripheral input device 104 are communicatively coupled based on a human interface device (HID) protocol. The example peripheral input device 104 includes HID protocol circuitry 132 to facilitate communication with the user device 102. Although the HID protocol circuitry 132 may be implemented by dedicated logic circuitry, in this example, the HID protocol circuitry 132 is implemented by the processor circuitry 130 of the peripheral input device 104. The user device 102 includes HID driver circuitry 134 to facilitate communication with the peripheral input device 104. Although the HID driver circuitry 134 may be implemented by dedicated logic circuitry, in this example, the HID driver circuitry 134 is implemented by instructions executed on the processor circuitry 110 of the user device 102. In some examples, the HID protocol implemented by the user device 102 and the peripheral input device 104 is a universal serial bus (USB)-based protocol. In other examples, another type of HID protocol, such as a Bluetooth® HID protocol is used to facilitate communication between the mouse 104 and the user device 102. Thus, the example peripheral device 104 of FIG. 1 can include a wireless input device (e.g., a wireless mouse) or an input device coupled to the user device 102 via, for example, a USB cable.

In the example of FIG. 1, the task determining circuitry 128 of the peripheral input device or mouse 104 transmits (via the HID protocol circuitry 132), the coordinates of the mouse 104 to the user device 102. In response, the processor circuitry 110 of the user device 102 causes, for example, a cursor on the display screen 106 of the user device 102 to move based on the coordinates received from the mouse 104. In other examples, the task determining circuitry 128 of the mouse 104 transmits indications of user input(s) received via the buttons 116, 118, 120 and/or the wheel 122 and the processor circuitry 110 of the user device 102 responds to the input(s).

When the user device 102 is in use by the user (e.g., receiving input(s) via the mouse 104, the keyboard 108, etc.), the device 102 is in a working system power state, also known as an S0 system power state. The user device 102 is fully operational in the S0 system power state in that the display screen 106 is turned on, the application(s) 112 are being executed by processor circuitry 110 of the device 102, etc. In the example of FIG. 1, the processor circuitry 110 can instruct the user device 102 to move or transition from the working system power state (S0) in which the device is fully operational to a connected standby mode (S0 low-power idle state) after a threshold period of time without receiving any user inputs at the user device 102 (e.g., five minutes, ten minutes). When the example user device 102 of FIG. 1 is in the connected standby mode, the display screen 106 is turned off and one or more application(s) 112 running on the user device 102 are suspended, but the user device 102 remains connected to the Internet via one or more wired or wireless connection(s). In the connected standby mode, the example user device 102 can be quickly transitioned to return to the fully operational or working system power state (S0) in response to, for example, the user selecting a key on the keyboard 108 of the user device 102.

In some examples, the processor circuitry 110 can cause the user device 102 (e.g., the operating system 111) to move to a locked state prior to entering the connected standby mode. When the user device 102 is in the locked state, the applications(s) 112 and/or other content on the device 102 can be accessed in response to a user providing a password or other identifying information (e.g., facial recognition based an image of the user's face captured via a camera of the device 102). The password and/or other identifying information can be provided via a login screen presented by the operating system 111 via the display screen 106 to move the device 102 to an unlocked state.

In the example of FIG. 1, the user device 102 can transition between device states (e.g., power states such as the connected standby mode and the working system power state; lock states) based on detection of a presence of the user relative to the peripheral input device 104 and before the user provides an input at the user device 102 and/or the peripheral input device 104 to wake the device 102. The example peripheral input device 104 of FIG. 1 includes one or more user presence detection sensors 136 to detect a presence of the user relative to the peripheral input device 104 and, thus, by extension, the user device 102. In the example of FIG. 1, the user presence detection sensor(s) 136 can include time-of-flight senso(s), radar-based user presence detection sensor(s), infrared-based user presence detection sensor(s), vision-based user presence detection sensor(s) (e.g., a camera), and/or combinations thereof. The user presence detection sensor(s) 136 can be calibrated to detect a presence of user(s) of the device 102 within a threshold distance of the sensor(s) 136, such as four feet, two feet, etc. In examples in which the user presence detection sensor(s) 136 include time-of-flight sensors, the user presence detection sensor(s) 136 can be calibrated to emit light at periodic intervals, such as every two seconds, every five seconds, etc. to identify changes in user presence.

The example peripheral input device 104 of FIG. 1 includes a switch 138 (e.g., push button, a sliding switch) that is accessible to a user via the housing 114 of the mouse and is communicatively coupled to the user presence detection sensor(s) 136. The switch 138 enables the user to control operation of the user presence detection sensor(s) 136. In some examples, the user may wish to turn off the user presence detection sensor(s) 136 to, for instance, preserve battery life of the peripheral input device 104.

In the example of FIG. 1, the signals output by the user presence detection sensor(s) 136 are processed by subject detection circuitry 140 of the peripheral input device 104. The subject detection circuitry 140 detects or recognizes a presence or an absence of user(s) relative to the peripheral input device 104 based on the signals output by the user presence detection sensor(s) 136. In the example of FIG. 1, the subject detection circuitry 140 is implemented by executable instructions executed on the processor circuitry 130 of the peripheral input device 104. The example processor circuitry 130 of FIG. 1 implements sensor driver circuitry 142 to facilitate communication between the user presence detection sensor(s) 136 and the subject detection circuitry 140.

The subject detection circuitry 140 analyzes the signals output by the user presence detection sensor(s) 136 to determine a user presence state, namely, whether (a) a subject is present relative to the peripheral input device 104 (i.e., a present state) and, thus, within a detection range of the user presence detection sensor(s) 136 of the peripheral use device 104 or (b) no user(s) are detected within the detection range of the sensor(s) 136 (i.e., an absent state). The subject detection circuitry 140 can detect the presence or absence of the user(s) relative to the detection range of the sensor(s) 136 based on, for example, measurements of the amount of time between emission of a wave pulse, reflection off a subject, and return to the sensor, amplitude changes in the signal data, etc. The subject detection circuitry 140 outputs report(s) indicating the user presence state (i.e., present state, absent state) as determined based on the analysis of the signals from the user presence detection sensor(s) 136. In the example of FIG. 1, the report(s) including the user presence state are transmitted to the user device 102 via HID sensor protocol circuitry 144. Although the HID sensor protocol circuitry 144 may be implemented by dedicated logic circuitry, in this example, the HID sensor protocol circuitry 144 is implemented by the processor circuitry 130 of the peripheral input device 104.

The example user device 102 of FIG. 1 includes HID sensor driver circuitry 146 to facilitate communication with the HID sensor protocol circuitry 144 of the peripheral input device 104 and, in particular, to receive the user presence state report(s) output by the subject detection circuitry 140. Although the HID sensor driver circuitry 146 may be implemented by dedicated logic circuitry, in this example, the HID sensor driver circuitry 146 is implemented by instructions executed on the processor circuitry 110 of the user device 102.

In the example of FIG. 1, the user presence state reports output by the subject detection circuitry 140 of the peripheral input device 104 are analyzed by device control circuitry 152 of the user device 102. The device control circuitry 152 of FIG. 1 controls a power state (e.g., connected standby mode, working system power state) and/or a lock state (e.g., access to the applications 112 based on user identifying information) of the user device 102 based on the user presence state identified by the subject detection circuitry 140 and without user input(s) received at, for instance, the mouse 104, the keyboard 108, and/or other input devices coupled to the user device 102. In the example of FIG. 1, the device control circuitry 152 is implemented by the (e.g., main) processor circuitry 110 of the user device 102. In other examples, the device control circuitry may be implemented by dedicated logic circuitry.

In some examples, the user device 102 is in the connected standby or low power state and the subject detection circuitry 140 of the peripheral input device 104 reports that a presence of a subject has been detected within a range of the user presence detection sensor(s) 136 (i.e., the user presence state is the present state). In response to report(s) from the subject detection circuitry 140 indicating the presence of the user relative to the peripheral input device 104, the device control circuitry 152 determines that the user device 102 should exit the connected standby mode (S0 low-power idle state) and move to the working system power state (S0). The device control circuitry 152 transmits instructions that are executed by, for instance, the processor circuitry 110 of the user device 102 to wake the hardware devices of the user device 102 from the connected standby mode. For instance, the display screen 106 is turned on to enable the user to authenticate his or her identity (e.g., via entry of a password and/or facial recognition via a camera) and access the application(s) 112 installed on the user device 102.

In some examples, when the user device 102 is in the working system power state (S0), the user may be using the user device 102 but not actively providing inputs to the device 102. For instance, the user may be watching a video on the display screen 106 without providing inputs via the mouse 104 or the keyboard 108. The subject detection circuitry 140 of the peripheral input device 104 can periodically report the user presence state to the device control circuitry 152 based on analysis of the corresponding signals output by the user presence detection sensor(s) 136 over time. For example, the subject detection circuitry 140 can periodically send reports to the device control circuitry 152 to confirm that the user presence state continues to be the present state based on the signal analysis. In response to the reports from the subject detection circuitry 140 indicating that the user presence state is the present state, the device control circuitry 152 can maintain the user device 102 in the working system power state (S0). In such examples, the device control circuitry 152 prevents the user device 102 from moving to the locked state or the connected standby mode despite the absence of user input(s) at the user device 102 for a threshold period of time (e.g., the device control circuitry 152 refrains from outputting instructions to change the device state). The sensitivity of the subject detection circuitry 140 in outputting user presence state reports to the device control circuitry 152 (e.g., ten times a second, once every second, etc.) can be user-defined and/or adjustable based on user input(s).

In some examples, based on the signals output by the user presence detection sensor(s) 136 over time, the subject detection circuitry 140 of the peripheral input device 104 determines that no users are present within a detection range of the user presence detection sensor(s) 136 (e.g., because the user(s) have moved away from the peripheral input device 104 beyond the range of the user presence detection sensor(s) 136). In some examples, the subject detection circuitry 140 analyzes the sensor data to check a status of the user presence state in response to notification(s) from the user device 102 indicating that a user input has not been detected at the device within a threshold period of time while the device 102 is in the working system power state. For instance, the subject detection circuitry 140 can detect a change in the sensor data corresponding to the signals output by the user presence detection sensor(s) 136 indicating that the user is no longer detected within the range of the sensor(s) 136 (e.g., amplitude changes in the signal data). In such examples, the subject detection circuitry 140 reports user presence state as the absent state to the device control circuitry 152.

In response to report(s) from the subject detection circuitry 140 indicating that the user presence state relative to the peripheral input device 104 has changed from the present state to the absent state, the device control circuitry 152 causes the lock state and, in some instances, the power state of the user device 102 to be adjusted. In some examples, the subject detection circuitry 140 output(s) the reports indicating that the user is no longer present if the subject detection circuitry 140 determines, based on the signal data, that the user has not been present for a threshold duration of time (e.g., five minutes, three minutes, or other user-defined threshold period of time). In some examples, the subject detection circuitry 140 output(s) the reports indicating that the user is no longer present in response to detecting the change in user presence state and the device control circuitry 152 determines when to adjust the lock state and power state of the user device 102 based on threshold timing rules, as disclosed herein.

For instance, based on the reports from the subject detection circuitry 140, the device control circuitry 152 can determine that the presence of the user has not been detected for a first duration of time (e.g., three minutes). In response, in some examples, the device control circuitry 152 generates instructions to cause, for instance, the display screen 106 to dim if the presence of the user has not been detected for a first duration of time (e.g., three minutes). In some examples, the device control circuitry 152 instructs the operating system 111 to move the user device 102 to a locked state such that the user has to provide identifying information to access the applications 112 on the device 102 (e.g., if the user did not already lock the device 102 prior to walking away from the device 102) if the presence of the user has not been detected for a second duration of time (e.g., five minutes). In some examples, based on the reports from the subject detection circuitry 140, the device control circuitry 152 determines that the user presence state has been the absent state for a third duration of time (e.g., ten minutes). In such examples, the device control circuitry 152 instructs the user device 102 to enter the connected standby mode (S0 low-power idle state). When the user device 102 is in the connected standby mode, the device control circuitry 152 can cause the user device 102 to move from the connected standby mode to the working system power state (S0) in response to an indication from the subject detection circuitry 140 that the user presence state has returned to the present state (i.e., a presence of a user has been detected within a range of the user presence detection sensor(s) 136).

Although in the example of FIG. 1, the subject detection circuitry 140 is implemented by the processor circuitry 130 of the peripheral input device and the device control circuitry 152 is implemented by the processor circuitry 110, in some examples, one or more components of the subject detection circuitry 140 and/or the device control circuitry 152 is implemented by instructions executed on a processor of a wearable or non-wearable user device 156 different than the peripheral input device 104 and the user device 102 and/or on one or more cloud-based devices 158 (e.g., one or more server(s), processor(s), and/or virtual machine(s)).

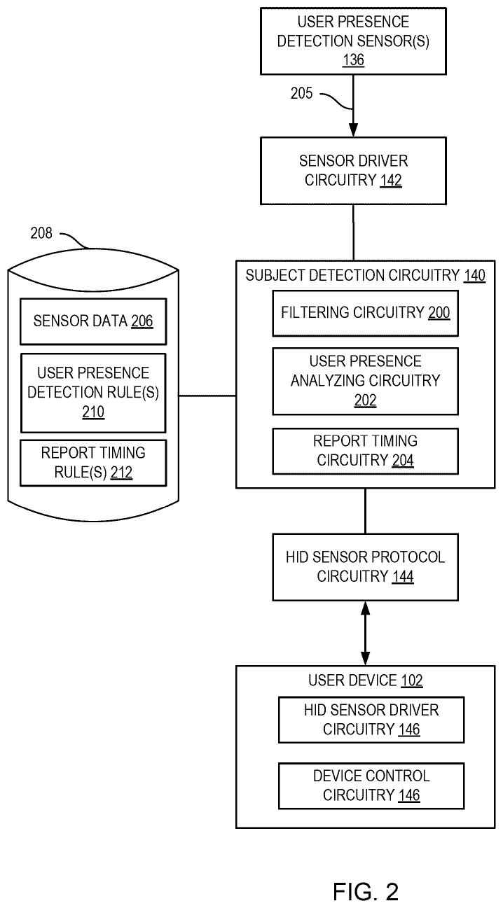

FIG. 2 is a block diagram of the example subject detection circuitry 140 of FIG. 1 to identify a user presence state (i.e., a present state or an absent state) relative to the peripheral input device 104. The subject detection circuitry 140 of FIG. 2 may be instantiated (e.g., creating an instance of, bring into being for any length of time, materialize, implement, etc.) by processor circuitry such as a central processing unit executing instructions. Additionally or alternatively, the subject detection circuitry 140 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

The example subject detection circuitry 140 of FIG. 2 includes filtering circuitry 200, user presence analyzing circuitry 202, and report timing circuitry 204.

In the example of FIG. 2, signals 205 output by the user presence detection sensor(s) 136 are transmitted (e.g., via the sensor driver circuitry 142) to the subject detection circuitry 140. The filtering circuitry 200 of the subject detection circuitry 140 performs operations such as filtering the raw signal data, removing noise from the signal data, converting the signal data from analog data to digital data, etc. Sensor data 206 corresponding to the filtered signals 205 can be stored in a database 208. In some examples, the subject detection circuitry 140 includes the database 208. In some examples, the database 208 is located external to the subject detection circuitry 140 in a location accessible to the subject detection circuitry 140 as shown in FIG. 2.

The user presence analyzing circuitry 202 analyzes the sensor data 206 to detect (e.g., predict, recognize, determine, identify) if a subject is within the detection range of the user presence detection sensor(s) 136 and, thus, near enough to the peripheral input device 104 to suggest that the user is about to use or is using the user device 102. The user presence analyzing circuitry 202 analyzes the sensor data 206 based on one or more user presence detection algorithm(s) or rule(s) 210. The user presence detection rule(s) 210 can be defined based on user input(s) and stored in the database 208.

The user presence detection rule(s) 210 can define, for instance, threshold time-of-flight measurements by the user presence detection sensor(s) 136 that indicate presence of the subject within the range of the user presence detection sensor(s) 136 (e.g., measurements of the amount of time between emission of a wave pulse, reflection off a subject, and return to the sensor). In some examples, the user presence detection rule(s) 210 define threshold distance(s) for determining that a subject is within proximity of the peripheral input device 104. In such examples, the user presence analyzing circuitry 202 determines the distance(s) based on the time-of-flight measurement(s) in the sensor data 206 and the known speed of the light emitted by the sensor(s) 136. In some examples, the user presence analyzing circuitry 202 identifies changes in the depth or distance values over time and detects whether the user is approaching the peripheral input device 104 (and, thus, by extension, the user device 102) or is moving away from the peripheral input device 104 based on the changes. The threshold time-of-flight measurement(s) and/or distance(s) for the sensor data 206 can be based on the range of the user presence detection sensor(s) 136 in emitting pulses. In some examples, the threshold time-of-flight measurement(s) and/or distance(s) are based on user-defined reference distances for determining that a user is near or approaching the peripheral input device 104 as compared to simply being in the environment in which the peripheral input device 104 and the user are both present.

In some examples, the user presence analyzing circuitry 202 can detect a number of subjects within the detection of the sensor(s) 136 (e.g., radar based or vision based user presence detection sensors). The user presence detection rule(s) 210 can define, for instance, a minimum distance at which the subjects can be considered as present relative to the peripheral user device 104 such that one or more of the subject could be considered an onlooker (e.g., a subject in the environment other than the subject primarily using the user device 102).

The user presence detection rule(s) 210 can be tuned or adjusted over time based on learned user activity at the user device. For instance, the distance(s) for determining that a user is near or approaching the peripheral input device 104 can be adjusted based on feedback from the user presence analyzing circuitry 202. For instance, the user presence analyzing circuitry 202 can determine, based on the sensor data 206 generated over time, that a distance of the subject relative to the peripheral input device 104 does not decrease over time when the subject is initially detected at a particular distance from peripheral input device 104. For instance, the user may be walking by the peripheral input device 104 as the user moves in the environment, but the user does not move toward the peripheral input device 104. In such instances, the threshold distance for determining user presence relative to the peripheral input device 104 can be adjusted (e.g., via machine learning updates and/or user input(s)) to reduce false positives.

In the example of FIG. 2, the user presence analyzing circuitry 202 can detect, based on the sensor data 206 and the rule(s) 210, that no users are proximate to the peripheral input device 104. In such examples, the user presence analyzing circuitry 202 identifies a user presence state as the absent state. In some examples, the user presence analyzing circuitry 202 outputs a report for the transmission to the device control circuitry 152 indicating that the user presence state is the absent state. After a period of time, that user presence analyzing circuitry 202 can detect, based on the sensor data 206 and the rule(s) 210, that a user is proximate to the peripheral input device 104. In such examples, the user presence analyzing circuitry 202 identifies the user presence state as the present state. The user presence analyzing circuitry 202 outputs a report for the transmission to the device control circuitry 152 indicating detection of the user proximate to the peripheral input device 104 (i.e., the user presence state is the present state). The report(s) generated by the user presence analyzing circuitry 202 are transmitted to the user device 102 via the HID sensor protocol circuitry 144 of the peripheral input device 104 and the HID sensor driver circuitry 146 of the user device 102.

In the example of FIG. 2, the report timing circuitry 204 monitors the duration of time for which the user presence analyzing circuitry 202 detects the respective user presence states (i.e., the present state, the absent state). In some examples, the user presence analyzing circuitry 202 outputs the user presence state report(s) based on the monitoring by the report timing circuitry 204 and report timing rule(s) 212. The report timing rule(s) 212 can define time thresholds to cause the user presence analyzing circuitry 202 to output additional reports indicating the user presence state continues to be present state or the absent state over time, or that a change in the user presence state has been detected.

For instance, in some examples, the report timing rule(s) 212 can indicate that after detecting that a user is proximate to the peripheral input device 104, the user presence analyzing circuitry 202 should output a report twice every second if the user presence analyzing circuitry 202 continues to determine that the user presences state is the present state. The report timing circuitry 204 communicates with the user presence analyzing circuitry 202 to cause the user presence analyzing circuitry 202 to output the report when the report timing rule(s) 212 are satisfied. As disclosed herein, in response to the periodic reports from the user presence analyzing circuitry 202 indicating that the user presence state corresponds to the present state, the device control circuitry 152 of the user device 102 can maintain the device in the working system state (S0) even if no user input(s) have been received for a period of time. The report timing rule(s) 212 can be defined based on user inputs and tuned to adjust the frequency of the user presence state reports from the user presence analyzing circuitry 202. The report timing rule(s) 212 can define the sensitivity of the user presence analyzing circuitry 202 in outputting the user presence state reports and, thus, the sensitivity of the device control circuitry 152 in responding to changes in the user presence state.

In other examples, when the user device 102 is in the working system power state, the user presence analyzing circuitry 202 refrains from analyzing the sensor data 206 and outputting the user presence state report(s) until the user presence analyzing circuitry 202 receives notification(s) from the task determining circuitry 128 and/or the device control circuitry 152 indicating that no user inputs (e.g., physical inputs such as touch inputs on the display screen 106, moving a mouse, etc.) have been detected by the peripheral input device(s) 104 and/or by the user device 102 for a threshold period of time. In such examples, because user inputs are actively being received at or detected by the user device 102 and/or the peripheral input device(s) 104, verification of the user presence state is not needed. Thus, in such examples, the user presence analyzing circuitry 202 refrains from analyzing the sensor data 206 to conserve processing resources (e.g., the user presence analyzing circuitry 202 is in a deactivated state). For example, the task determining circuitry 128 can provide notification(s) to the user presence analyzing circuitry 202 with respect to the last time the task determining circuitry 128 processed coordinates of the mouse location. The device control circuitry 152 can transmit notification(s) to the user presence analyzing circuitry 202 indicating that no user input(s) have been detected by the user device 102 for a particular duration of time based on information from the application(s) 112 and/or the operating system 111. In response to such notifications, the user presence analyzing circuitry 202 analyzes the sensor data 206 to determine (e.g., confirm, verify) the user presence state and output the report(s).

In the example of FIG. 2, the user presence analyzing circuitry 202 can determine that the user is no longer proximate to the peripheral input device 104 based on the sensor data 206 and the user presence detection rule(s) 210. In response to the user presence state change (i.e., a present state to an absent state), the user presence analyzing circuitry 202 outputs a report indicating that the user presence state has changed from the present state to the absent state for transmission to the device control circuitry 152 of the user device 102.

In some examples, the user presence analyzing circuitry 202 outputs the report indicating the change in the user presence state from the present state to the absent state if the report timing circuitry 204 determines that a threshold period of time for detecting that the user is not proximate to the peripheral input device 104 has been satisfied based on the report timing rule(s) 212. For example, the report timing circuitry 204 can determine that the user presence analyzing circuitry 202 has identified the user presence state as the absent state based on the sensor data 206 for a first threshold period of time (e.g., three minutes) based on the reports generated by the user presence analyzing circuitry 202. In response to the threshold time period of time for identifying the user presence state as the absent state being satisfied, the report timing circuitry 204 can instruct the user presence analyzing circuitry 202 to output the report(s) indicating that the user presence state has changed. The threshold time for outputting the report(s) indicating that the user presence state is the absent state can prevent excessive or unnecessary changes to the state of the device 102 (e.g., the locked stated of the operating system 111) when, for instance, the user steps away from the user device 102 and returns within a short amount of time (e.g., two minutes).

In some examples, after sending out a report indicating that the user presence state has changed from the present state to the absent state, the user presence analyzing circuitry 202 refrains from outputting further reports indicating that the user is not proximate to the peripheral input device 104 to conserve power at the peripheral input device 104. For example, if the report timing circuitry 204 determines that the user presence analyzing circuitry 202 has identified the user presence state as the absent state for longer than a second threshold period of time (e.g., ten minutes), the user presence analyzing circuitry 202 can refrain from outputting further reports indicating the absence of the user until the user presence analyzing circuitry 202 detects that the user is present again.

In some examples, the device control circuitry 152 of the user device 102 transmits a report indicating to the subject detection circuitry 140 indicating that the device 102 has been placed in the connected standby mode in response to the report(s) from the user presence analyzing circuitry 202 indicating that the user presence state changed from the present state to the absent state. In such examples, in response to the indication from the device control circuitry 152 that the user device 102 is in the connected standby mode, the user presence analyzing circuitry 202 can refrain from outputting further reports indicating the absence state. The user presence analyzing circuitry 202 can resume outputting reports in response to the user presence analyzing circuitry 202 detecting that the user is proximate to the peripheral input device 104 (e.g., a change from the absent state to the present state). The example user presence analyzing circuitry 202 of FIG. 2 continues to analyze the sensor data 206 corresponding to the signals 205 output by the user presence detection sensor(s) 136 to monitor changes in user proximity relative to the peripheral input device 104 and, thus, changes in the user presence states.

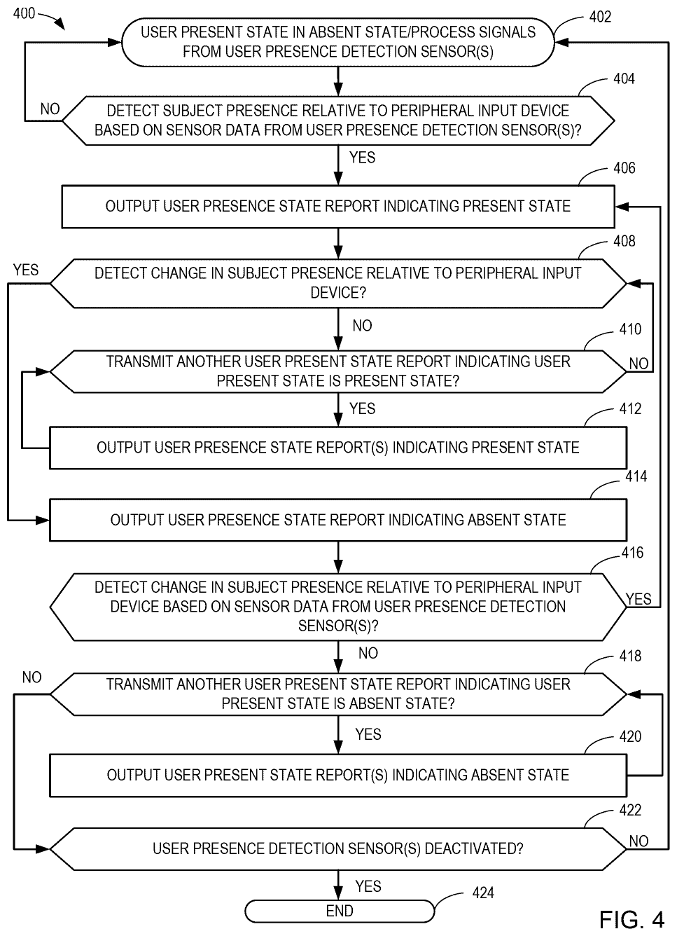

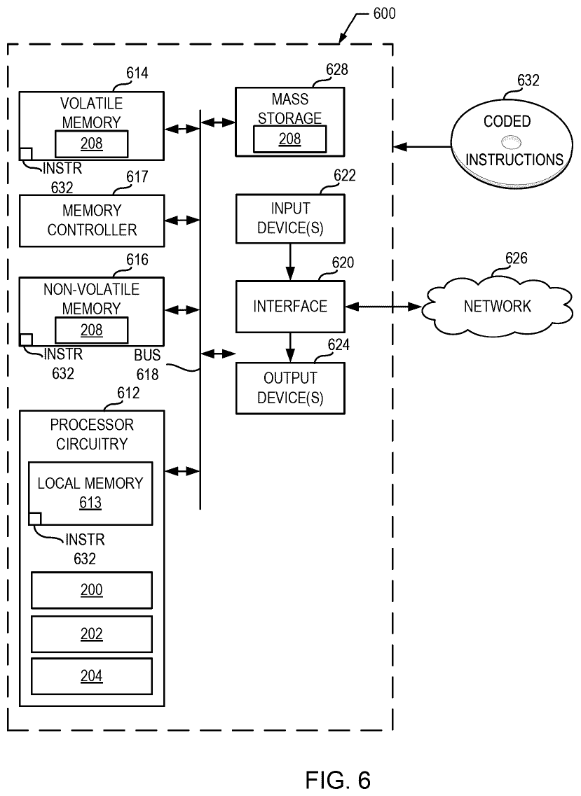

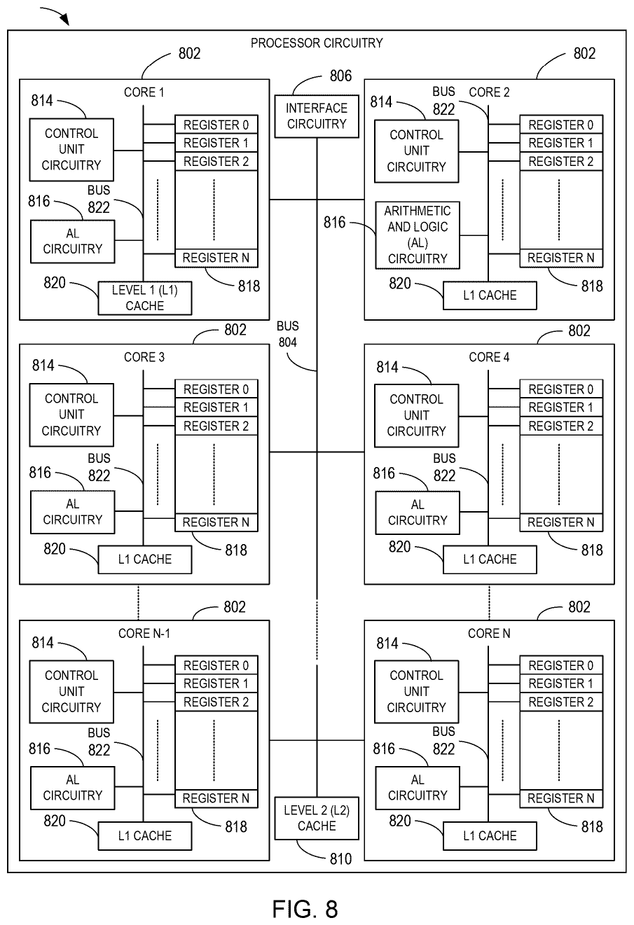

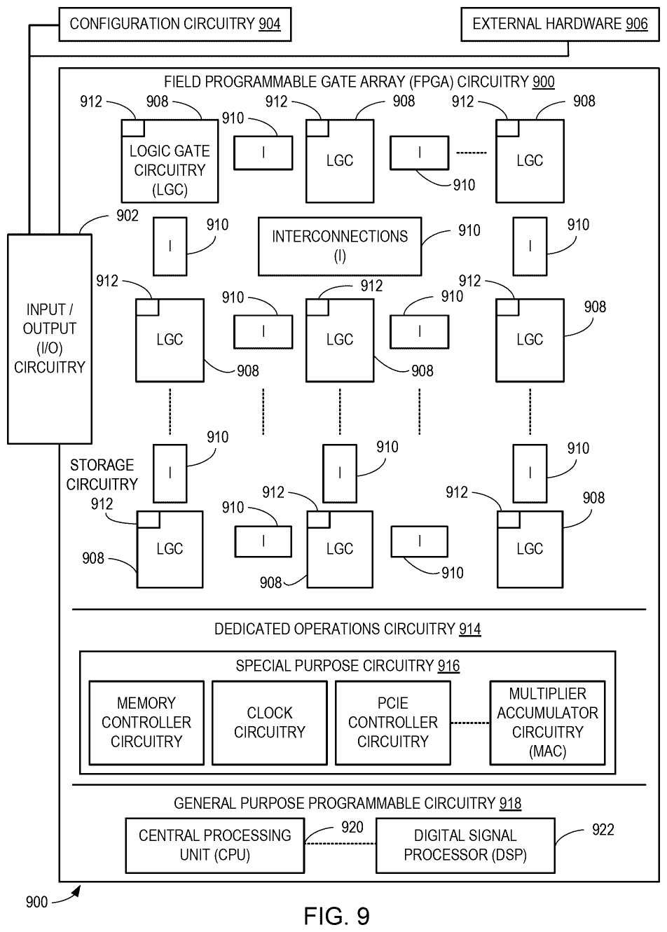

In some examples, the subject detection circuitry 140 includes means for filtering. For example, the means for filtering may be implemented by the filtering circuitry 200. In some examples, the filtering circuitry 200 may be instantiated by processor circuitry such as the example processor circuitry 612 of FIG. 6. For instance, the filtering circuitry 200 may be instantiated by the example general purpose processor circuitry 800 of FIG. 8 executing machine executable instructions such as that implemented by at least block 402 of FIG. 4. In some examples, the filtering circuitry 200 may be instantiated by hardware logic circuitry, which may be implemented by an ASIC or the FPGA circuitry 900 of FIG. 9 structured to perform operations corresponding to the machine readable instructions. Additionally or alternatively, the filtering circuitry 200 may be instantiated by any other combination of hardware, software, and/or firmware. For example, the filtering circuitry 200 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the subject detection circuitry 140 includes means for analyzing user presence. For example, the means for analyzing may be implemented by the user presence analyzing circuitry 202. In some examples, the user presence analyzing circuitry 202 may be instantiated by processor circuitry such as the example processor circuitry 612 of FIG. 6. For instance, the user presence analyzing circuitry 202 may be instantiated by the example general purpose processor circuitry 800 of FIG. 8 executing machine executable instructions such as that implemented by at least blocks 404, 406, 408, 412, 414, 416, 420 of FIG. 4. In some examples, the user presence analyzing circuitry 202 may be instantiated by hardware logic circuitry, which may be implemented by an ASIC or the FPGA circuitry 900 of FIG. 9 structured to perform operations corresponding to the machine readable instructions. Additionally or alternatively, the user presence analyzing circuitry 202 may be instantiated by any other combination of hardware, software, and/or firmware. For example, the user presence analyzing circuitry 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the subject detection circuitry 140 includes means for report timing. For example, the means for report timing may be implemented by the report timing circuitry 204. In some examples, the report timing circuitry 204 may be instantiated by processor circuitry such as the example processor circuitry 612 of FIG. 6. For instance, the report timing circuitry 204 may be instantiated by the example general purpose processor circuitry 800 of FIG. 8 executing machine executable instructions such as that implemented by at least blocks 410, 418 of FIG. 4. In some examples, the report timing circuitry 204 may be instantiated by hardware logic circuitry, which may be implemented by an ASIC or the FPGA circuitry 900 of FIG. 9 structured to perform operations corresponding to the machine readable instructions. Additionally or alternatively, the report timing circuitry 204 may be instantiated by any other combination of hardware, software, and/or firmware. For example, the report timing circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the subject detection circuitry 140 of FIG. 1 is illustrated in FIG. 2, one or more of the elements, processes, and/or devices illustrated in FIG. 2 may be combined, divided, re-arranged, omitted, eliminated, and/or implemented in any other way. Further, the example filtering circuitry 200, the example user presence analyzing circuitry 202, the example report timing circuitry 204 and/or, more generally, the example subject detection circuitry 140 of FIG. 1, may be implemented by hardware alone or by hardware in combination with software and/or firmware. Thus, for example, any of the example filtering circuitry 200, the example user presence analyzing circuitry 202, the example report timing circuitry 204 and/or, more generally, the example subject detection circuitry 140, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example subject detection circuitry 140 of FIG. 1 may include one or more elements, processes, and/or devices in addition to, or instead of, those illustrated in FIG. 2, and/or may include more than one of any or all of the illustrated elements, processes, and devices.

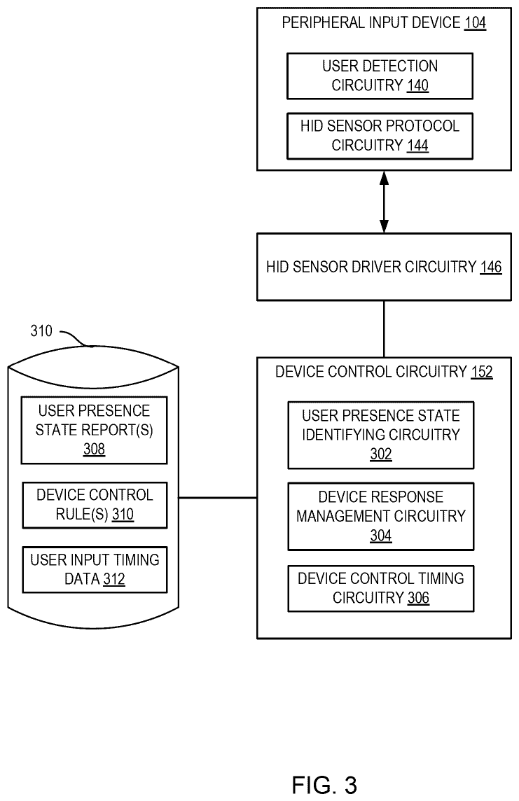

FIG. 3 is a block diagram of the example device control circuitry 152 of the user device 102 of FIG. 1 to control a device state (e.g., a lock state, a power state) of the user device 102 in response to the user presence states identified by the subject detection circuitry 140 of FIGS. 1 and/or 2. The device control circuitry 152 of FIG. 2 may be instantiated (e.g., creating an instance of, bring into being for any length of time, materialize, implement, etc.) by processor circuitry such as a central processing unit executing instructions. Additionally or alternatively, the device control circuitry 152 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

The example device control circuitry 152 of FIG. 3 includes user presence state identifying circuitry 302, device response management circuitry 304, and device control timing circuitry 306.

In the example of FIG. 3, user presence state report(s) 308 output by the subject detection circuitry 140 (e.g., the user presence analyzing circuitry 202 of FIG. 2) and accessed by the device control circuitry 152 can be stored in a database 309. In some examples, the device control circuitry 152 includes the database 309. In some examples, the database 309 is located external to the device control circuitry 152 in a location accessible to the subject detection circuitry 140 as shown in FIG. 3.

The user presence state identifying circuitry 302 analyzes the user presence state report(s) 308 to determine if the report(s) 308 indicate that the user presence state is the present state (i.e., a user is detected within the range of the user presence detection sensor(s) 136 of the peripheral input device 104) or the absent state (i.e., no user is detected within the range of the user presence detection sensor(s) 136 of the peripheral input device 104). In some examples, the user presence state report(s) 308 identify a number of subjects detected in the range of the sensor(s) 136.

The device response management circuitry 304 controls one or more device states (e.g., operational states) of the user device 102 in response to the user presence state(s) recognized or registered by the user presence state identifying circuitry 302 based on the user presence state report(s) 308. The device response management circuitry 304 outputs instructions to cause the user device 102 (e.g., the operating system 111) to adjust a lock state and, in some examples, a power state of the user device 102 based on the user presence states. In some examples, the device response management circuitry 304 outputs instructions to cause the display control circuitry 107 of the user device 102 to adjust a brightness of the display screen 106 of the user device 102 based on the user presence states. The device response management circuitry 304 controls the device states (e.g., display screen state, lock states, the power states) of the user device based on device control rule(s) 310. The device control rule(s) 310 can be defined based on user input(s) and stored in the database 309.

For example, the device control rule(s) 310 can indicate that when the user device 102 is in the connected standby mode (S0 low-power idle state) and the user presence state identifying circuitry 302 determines that the user presence state is the present state based on the report(s) 308, then the device response management circuitry 304 should cause the device 102 to move to the working system power state (S0). The device control rule(s) 310 can indicate that the operating system 111 should cause a login screen to be displayed via the display screen 106 of the user device 102 in response to the device 102 moving to the working system power state (S0).

The device control rule(s) 310 can indicate that if the user device 102 is in the working power state and the user presence state identifying circuitry 302 determines that the user presence state is the present state based on the report(s) 308, the user device 102 should remain in the working power state even if no user input(s) have been received at the user device 102. For example, the device response management circuitry 304 can refrain from outputting instructions to cause the device 102 move to the locked state. Such rule(s) 310 can account for instances in which, for example, the user is reading an article or watching a video on the display screen 106 but not actively providing input(s) at the device 102.

The device control rule(s) 310 can indicate that when the device is in the working system power state and the user presence state identifying circuitry 302 determines that the user presence state is the absent state based on the report(s) 308, the brightness of the display screen 106 of the user device 102 should be adjusted (e.g., to conserve power). For example, the device control rule(s) 310 can indicate that device response management circuitry 304 should cause the display control circuitry 107 to dim the display screen 106 when a first or initial report indicating that the user is absent is received from the user device 102 after receiving report(s) indicating the user presence state is a present state.

The device control rule(s) 310 can indicate that when the device is in the working system power state and the user presence state identifying circuitry 302 determines based on the report(s) 308 that the user presence state is the absent state for a first duration of time (e.g., based on the timing of reports received from the subject detection circuitry 140), the device response management circuitry 304 should check if the user locked the device 102 before leaving (e.g., based on a state of the operating system 111). If the device 102 is unlocked and the user presence state is the absent state, then the device control rule(s) 310 indicate that the device response management circuitry 304 should cause the device 102 (e.g., the operating system 111) to move to a locked state. In the locked state, the operating system 111 can cause a login screen to be presented via the display screen 106 of the user device 102 and the user provides identifying information to (re-) access the applications 112 on the user device 102.

The device control rule(s) 310 can indicate that when the device 102 is in the locked state and the user presence state identifying circuitry 302 determines based on the report(s) 308 that the user presence state is the absent state for a second duration of time greater than the first duration of time (e.g., based on the timing of reports received from the subject detection circuitry 140), the device response management circuitry 304 should cause the user device 102 to move to the connected standby mode. Thus, in such instances, the rule(s) 310 indicate that because the user has not been detected proximate to the peripheral input device 104 for a threshold period of time, the user device 102 should move to the low power connected standby state to conserve power. In some examples, the device response management circuitry 304 outputs a report for transmission to the subject detection circuitry 140 that the device 102 has entered the connected standby state. As disclosed herein, the subject detection circuitry 140 can refrain from transmitting further reports indicating that the user presence state is the absent state in response to the device 102 entering the connected standby state.

In some examples, the device control rule(s) 310 include rule(s) for controlling the device 102 when two or more users are detected as present relative to the peripheral input device 104 and the user device 102 is in the working power state (S0). For example, in addition to identifying the user present state, the user presence state report(s) 308 can identify the number of detected subjects. Based on the report(s) 308, the user presence state identifying circuitry 302 can determine that two or more subjects are detected within the detection range of the user presence detection sensor(s) 136 of the peripheral input device 104. The device control rule(s) 310 can include a rule stating that when two or more subjects are detected as present, the device response management circuitry 304 should cause the display control circuitry 107 to dim or blur the display screen 106 to protect content displayed on the display screen 106 from onlookers. In some examples, the device response management circuitry 304 can cause an alert to be output (e.g., for presentation via the display screen 106) to notify a user of the device 102 that another subject has been detected within the range of the sensor(s) 136. The rule(s) 310 with respect how the device response management circuitry 304 should respond to potential onlooker subjects can be defined based on user input(s).

The device control rule(s) 310 can be tuned or adjusted over time based on learned user activity. For example, a duration of time for moving the device 102 to the connected standby mode can be adjusted to reduce instances in which device response management circuitry 304 moves the device 102 to the connected standby mode and then the user is detected as present shortly thereafter (e.g., within three minutes) to reduce wasteful power consumption by returning the device 102 to the working power state.

The device control timing circuitry 306 of the example device control circuitry 152 of FIG. 3 monitors the time at which the user presence state reports 308 are received from the subject detection circuitry 140. The device control timing circuitry 306 can identify a duration of time that the user presence state has been in the absent state based on the receipt of the corresponding user presence state reports. The device control timing circuitry 306 determines if time threshold(s) in the device control rule(s) 310 have been satisfied for adjusting the device state(s) (e.g., lock state, power state) of the user device 102. Based on the duration of time that the user presence state has been detected as the absent state and the corresponding device control rule(s) 310, the device response management circuitry 304 can adjust the device state(s) (e.g., display screen brightness, lock states, power state(s)) of the user device 102.

In some examples, the device control timing circuitry 306 monitors a time at which user inputs are detected by (e.g., processed by) the user device 102 (e.g., based on data from the application(s) 112, the operating system 111). User input timing data 312 can be stored in the database 310. The user inputs can include touch inputs via the display screen 106, user inputs from the peripheral input device(s) 104 that are detected by the user device 102 (e.g., changes in mouse position coordinates), etc. The device control timing circuitry 306 can output notification(s) to the subject detection circuitry 140 (e.g., via the HID sensor driver circuitry 146) indicating that a user input has not been detected for a threshold period of time based on the user input timing data 312. The threshold period of time can be defined in the device control rule(s) 310. The threshold period of time can be, for example, an amount of time that is less than a threshold for moving the device to the low power state. In response to such notifications, the user presence analyzing circuitry 202 analyzes the sensor data 206 to determine (e.g., confirm, verify) whether the user is present relative to the peripheral input device 104. Thus, in some examples, after the user device 102 has moved to the working system power state, the user presence analyzing circuitry 202 refrains from analyzing the sensor data 206 to determine the user presence state until the user presence analyzing circuitry 202 receives notification(s) from the device control timing circuitry 306 that the user input has not been detected by the user device 102 for a threshold period of time. Thus, the user presence analyzing circuitry 202 conserves processing resources while the user is actively providing inputs via the user device 102 and/or the peripheral input device(s) 104.

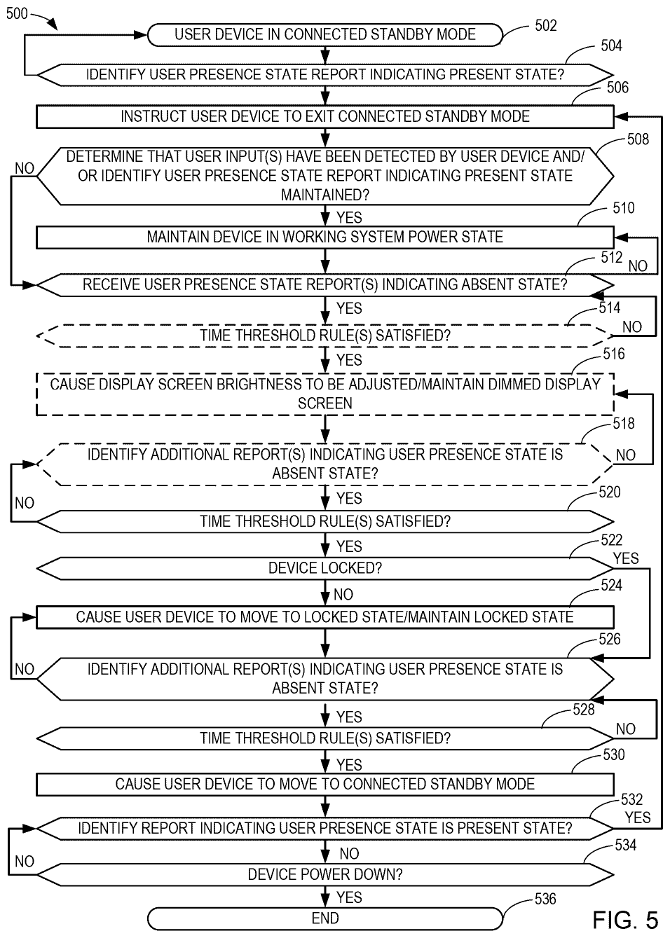

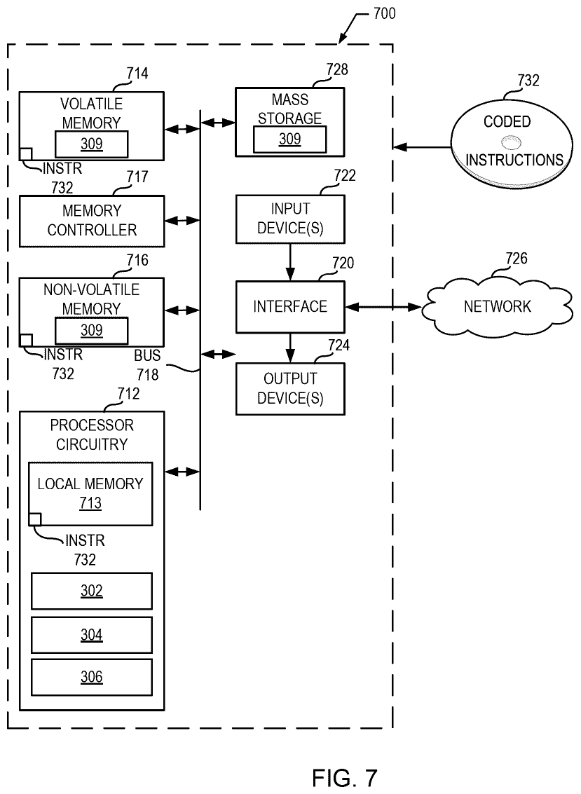

In some examples, the device control circuitry 152 includes means for identifying user presence states. For example, the means for identifying may be implemented by the user presence state identifying circuitry 302. In some examples, the user presence state identifying circuitry 302 may be instantiated by processor circuitry such as the example processor circuitry 712 of FIG. 7. For instance, the user presence state identifying circuitry 302 may be instantiated by the example general purpose processor circuitry 800 of FIG. 8 executing machine executable instructions such as that implemented by at least blocks 504, 508, 512, 518, 526, 532 of FIG. 5. In some examples, the user presence state identifying circuitry 302 may be instantiated by hardware logic circuitry, which may be implemented by an ASIC or the FPGA circuitry 900 of FIG. 9 structured to perform operations corresponding to the machine readable instructions. Additionally or alternatively, the user presence state identifying circuitry 302 may be instantiated by any other combination of hardware, software, and/or firmware. For example, the user presence state identifying circuitry 302 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device control circuitry 152 includes means for managing a device response. For example, the means for managing may be implemented by the device response management circuitry 304. In some examples, the device response management circuitry 304 may be instantiated by processor circuitry such as the example processor circuitry 712 of FIG. 7. For instance, the device response management circuitry 304 may be instantiated by the example general purpose processor circuitry 800 of FIG. 8 executing machine executable instructions such as that implemented by at least blocks 502, 506, 510, 516, 522, 524, 530, 534 of FIG. 5. In some examples, the device response management circuitry 304 may be instantiated by hardware logic circuitry, which may be implemented by an ASIC or the FPGA circuitry 900 of FIG. 9 structured to perform operations corresponding to the machine readable instructions. Additionally or alternatively, the device response management circuitry 304 may be instantiated by any other combination of hardware, software, and/or firmware. For example, the device response management circuitry 304 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the device control circuitry 152 includes means for device control timing. For example, the means for device control timing may be implemented by the device control timing circuitry 306. In some examples, the device control timing circuitry 306 may be instantiated by processor circuitry such as the example processor circuitry 712 of FIG. 7. For instance, the device control timing circuitry 306 may be instantiated by the example general purpose processor circuitry 800 of FIG. 8 executing machine executable instructions such as that implemented by at least blocks 514, 520, 528 of FIG. 5. In some examples, the device control timing circuitry 306 may be instantiated by hardware logic circuitry, which may be implemented by an ASIC or the FPGA circuitry 900 of FIG. 9 structured to perform operations corresponding to the machine readable instructions. Additionally or alternatively, the device control timing circuitry 306 may be instantiated by any other combination of hardware, software, and/or firmware. For example, the device control timing circuitry 306 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the device control circuitry 152 of FIG. 1 is illustrated in FIG. 3, one or more of the elements, processes, and/or devices illustrated in FIG. 3 may be combined, divided, re-arranged, omitted, eliminated, and/or implemented in any other way. Further, the example user presence state identifying circuitry 302, the example device response management circuitry 304, the example device control timing circuitry 306, and/or, more generally, the example device control circuitry 152 of FIG. 1, may be implemented by hardware alone or by hardware in combination with software and/or firmware. Thus, for example, any of the example user presence state identifying circuitry 302, the example device response management circuitry 304, the example device control timing circuitry 306, and/or, more generally, the example device control circuitry 152, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example device control circuitry 152 of FIG. 1 may include one or more elements, processes, and/or devices in addition to, or instead of, those illustrated in FIG. 2, and/or may include more than one of any or all of the illustrated elements, processes, and devices.

A flowchart representative of example hardware logic circuitry, machine readable instructions, hardware implemented state machines, and/or any combination thereof for implementing the subject detection circuitry 140 of FIG. 2 is shown in FIG. 4. A flowchart representative of example hardware logic circuitry, machine readable instructions, hardware implemented state machines, and/or any combination thereof for implementing the device control circuitry 152 of FIG. 2 is shown in FIG. 5. The machine readable instructions may be one or more executable programs or portion(s) of an executable program for execution by processor circuitry, such as the processor circuitry 612, 712 shown in the example processor platforms 600, 700 discussed below in connection with FIGS. 6 and 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example programs are described with reference to the flowcharts illustrated in FIGS. 4 and/or 5, many other methods of implementing the example subject detection circuitry 140 and/or the example device control circuitry 152 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to detect a user presence state relative to the peripheral input device 104 of FIG. 1. The machine readable instructions and/or the operations 400 of FIG. 4 begin at block 402, in which the filtering circuitry 200 of the subject detection circuitry 140 of FIG. 2 processes the signals from the user presence detection sensor(s) 136 (e.g., removes noise from the signals) and the user presence state detected by the user presence analyzing circuitry 202 is determined to be an absent state (i.e., no subject is detected within the detection range of the user presence detection sensor(s) 136 of the peripheral input device 104).

At block 404, the user presence analyzing circuitry 202 analyzes the sensor data 206 corresponding to the signal(s) output by the user presence detection sensor(s) 136 to determine if a subject is proximate to the peripheral input device 104 (i.e., within a detection range of the sensor(s) 136). The user presence analyzing circuitry 202 can determine that the user is proximate to the peripheral input device 104 based on the user presence detection rule(s) 210, which can define, for instances, changes in the sensor data 206 indicative of a presence of one or more users (e.g., measurements of the amount of time between emission of a wave pulse, reflection off a subject, and return to the sensor).

If, at block 404, the user presence analyzing circuitry 202 determines that a user is within the detection range of the sensor(s) 136 and, thus, proximate to the peripheral input device 104, the user presence analyzing circuitry 202 generates a report indicating that the user presence state is the present state and outputs the report for transmission (e.g., via a HID protocol) to the device control circuitry 152 associated with the user device 102 at block 406.

At block 408, the user presence analyzing circuitry 202 determines if there has been a change in the user presence state relative to the peripheral input device 104. In some examples, the user presence analyzing circuitry 202 checks if the user is present relative to the peripheral input device 104 in response to data from the device control timing circuitry 306 indicating that a threshold period of time has been exceeded since the last user input was received at the user device 102. In some examples, the user presence analyzing circuitry 202 checks if the user is present relative to the peripheral input device 104 in response to data from the task determining circuitry 128 indicating a time that the last user input was received at the peripheral input device 104 (e.g., the last time the task determining circuitry 128 determined coordinates of the mouse 104) and/or indicating that a threshold period of time has been exceeded since the last user input was processed by the peripheral input device 104. In some examples, the user presence analyzing circuitry 202 refrains from analyzing the sensor data 206 to detect changes in the user presence state until the user presence analyzing circuitry 202 received the notification(s) from the device control timing circuitry 306 and/or the task determining circuitry 128 indicating that no user input has been received at the user device 102 and/or the peripheral input device 104 for a threshold period of time. In response, the user presence analyzing circuitry 202 can detect that the user is no longer proximate to the peripheral input device 104 based on changes in the sensor data 206 and the user presence detection rule(s) 210. In other examples, the user presence analyzing circuitry 202 periodically checks the user presence state based on the sensor data 206 from the user presence detection sensor(s) 136 over time.

If, at block 408, the user presence analyzing circuitry 202 determines that there is no change in the user presence state, or put another way, that user presence state remains the present state, then at block 410, the report timing circuitry 204 determines if another report should be transmitted to the device control circuitry 152 indicating that the user presence state is the present state. In some examples, the report timing rule(s) 212 can indicate that the user presence analyzing circuitry 202 should periodically send reports to the user device 102 confirming that the user is still detected as present relative to the peripheral input device 104. The user presence analyzing circuitry 202 outputs such reports at block 412. In some examples, the report timing rule(s) 212 indicate that the user presence analyzing circuitry 202 should not analyze the user presence state and/or send reports to the user device 102 regarding the user presence state unless the user presence analyzing circuitry 202 has received notifications device control timing circuitry 306 or the task determining circuitry 128 indicating that no user input has been received at the user device 102 and/or the peripheral input device 104 for a threshold period of time.

If at block 408, the user presence analyzing circuitry 202 determines the user presence state has changed from the present state to the absent state (i.e., the user is no longer within the detection range of the sensor(s) 136 of the peripheral input device 104), then at block 414, the user presence analyzing circuitry 202 generates and outputs a report for transmission to the device control circuitry 152 indicating that the user presence state is the absent state.

At block 416, after outputting the report indicating that the user presence state is the absent state, the user presence analyzing circuitry 202 determines if there has been a change in the user presence relative to the peripheral input device 104 based on the sensor data 206 from the user presence detection sensor(s) 136 over time.

If, at block 416, the user presence analyzing circuitry 202 determines that there is no change in the user presence state, or put another way, that user presence state remains the absent state, then at block 418, the report timing circuitry 204 determines if another report should be transmitted to the user device indicating that the user presence state is the absent state. For example, the report timing rule(s) 212 can indicate that the user presence analyzing circuitry 202 should periodically sent reports to the user device 102 confirming that no user is detected relative to the peripheral input device 104. As disclosed herein, in some examples, the device control circuitry 152 adjusts a device state (e.g., a lock state, a power state) of the user device 102 differently based on the length of time for which the user presence state has been identified as the absent state. The user presence analyzing circuitry 202 outputs such reports at block 420.

In some examples, at block 418, the report timing rule(s) 212 indicate that the user presence analyzing circuitry 202 should sent the report(s) indicating the user absent state until, for instance, a report is received from the device control circuitry 152 indicating that the device has entered in the connected standby mode.

The example instructions 400 of FIG. 4 continue to monitor the user presence states relative to the peripheral input device 104 based on the sensor data generated by the user presence detection sensor(s) 136 over time. The example instructions 400 of FIG. 4 end when the user presence detection sensor(s) 136 are deactivated via the switch 152 of the peripheral input device 104 (blocks 422, 424).

FIG. 5 is a flowchart representative of example machine readable instructions and/or example operations 500 that may be executed and/or instantiated by processor circuitry to control the user device 102 of FIG. 1 based on the user presence state relative to the peripheral input device 104 of FIG. 1 (e.g., as identified by the subject detection circuitry 140 executing the instructions 400 of FIG. 4). The machine readable instructions and/or the operations 500 of FIG. 5 begin at block 502, in which the user device 102 is in the connected standby mode (S0 low power idle state).

At block 504, the user presence state identifying circuitry 302 of the device control circuitry 152 determines if a report has been received from the subject detection circuitry 140 indicating that the user presence state is the present state.

If, at block 504, the user presence state identifying circuitry 302 determines that the user presence state is the present state, then the device response management circuitry 304 instructs the user device 102 to exit the connected standby mode and enter the working system power state (S0) at block 506.

If, at block 504, the user presence state identifying circuitry 302 determines that the user presence state is the absent state, then the user device 102 remains in the connected standby mode (block 502). For example, the device response management circuitry 304 refrains from generating instructions that would cause the power state of the user device 102 to change.

When the device 102 is in the working system power state (block 506), then at block 508 the user presence state identifying circuitry 302 determines if user input(s) have been detected by the user device 102 (e.g., via peripheral input device(s), via touch inputs on the display screen 106, via a keyboard carried by the device 102, the user input timing data 312, etc.) and/or if (another) report has been received from the subject detection circuitry 140 indicating that the user presence state is the present state. For instance, the user presence state identifying circuitry 302 may receive periodic reports from the subject detection circuitry 140 indicating that the user presence state is the present state and, thus, the user is present relative to the peripheral input device 104 (e.g., even no user input has been received at the user device 102 for a period of time).

If, at block 508, the user presence state identifying circuitry 302 determines that user input(s) have been detected by the user device 102 and/or the report has been received indicating that the user presence state is the present state, the device response management circuitry 304 maintains the user device 102 in the user device 102 in the working system power state at block 510. Put another way, the device response management circuitry 304 does not generate an instruction to affect display screen state, the lock state, or the power state of the device 102.

If at block 508, the user presence state identifying circuitry 302 determines that user input(s) have not been detected by the user device 102 and/or a report indicating that the user presence state is the present state has not been received, then control proceeds to block 512 where the user presence state identifying circuitry 302 determines if a report has been received from the subject detection circuitry 140 indicating that the user presence state is the absent state. In some examples, the user presence analyzing circuitry 202 generates the reports indicating that the user presence state is the absent state in response to notification(s) from the device control timing circuitry 306 and/or the task determining circuitry 128 indicating that notifications have not been received at the user device 102 and/or the peripheral input device for a threshold period of time.

If, at block 512, the user presence state identifying circuitry 302 determines that a report indicating that the user presence state is the absent state has been received, then, in some examples, the device response management circuitry 304 selectively adjusts the device states (e.g., lock states, power states) of the user device based on a duration of time for which the user presence state is identified as the absent state as determined by, for instance, the time of the receipt of the reports 308. For example, at block 514, the device control timing circuitry 306 can determine if time threshold(s) in the device control rule(s) 310 have been satisfied for causing a brightness of the display screen 106 of the user device 102 to be adjusted in response to the absence of the user. If the device control rule(s) 310 have been satisfied, the device response management circuitry 304 instructs the display control circuitry 107 of FIG. 1 to dim the display screen 106 of the user device 102 at block 516.

At block 518, the user presence state identifying circuitry 302 determines if (e.g., another) report has been received indicating that the user presence state is the absent state. If another report indicating the absent state has been received, then at block 520, the device control timing circuitry 306 determines if the time threshold(s) in the device control rule(s) 310 for further adjusting the operational state of the user device 102 state are satisfied. If the device control rule(s) 310 are satisfied, then at block 522, the device response management circuitry 304 determines if the device 102 is in the locked state (e.g., based on a state of the operating system 111). If the device 102 is not in locked state, then at block 524, the device response management circuitry 304 causes the operating system 111 to move the device 102 to the locked state (e.g., display the login screen) based on the device control rule(s) 310. If the device control rule(s) 310 are not satisfied, then the user presence state identifying circuitry 302 continues to monitor for additional user presence state report(s) 308 (block 518).

At block 526, the user presence state identifying circuitry 302 determines if another report has been received indicating that the user presence state is the absent state. If another report has been received, then at block 528, the device control timing circuitry determines if the time threshold(s) in the device control rule(s) 310 for further adjusting the state of the user device 102 are satisfied. If the device control rule(s) 310 are satisfied, then at block 530, the device response management circuitry 304 causes the user device 102 to enter the connected standby mode based on the device control rule(s) 310.

The device response management circuitry 304 maintains the device 102 in the connected standby mode until a report indicating that the user presence state is the present state has been received and the device response management circuitry 304 returns the device to the working system power state (block 532). The instructions 500 of FIG. 5 end when the user device 102 is powered down (blocks 534, 536).

Although blocks 514-530 of the example instructions 500 of FIG. 5 include a staged adjustment of the device state(s) (e.g., operational states) of the user device 102 in response user presence state being the absent state over time, in other examples, the device response management circuitry 304 can, for instance, move the device directly to the locked state instead of dimming the display screen first, or move the device 102 to the connected standby mode after a threshold period of time instead of causing the device 102 to move to the locked state first.

FIG. 6 is a block diagram of an example processor platform 600 structured to execute and/or instantiate the machine readable instructions and/or the operations of FIG. 4 to implement the subject detection circuitry 140 of FIG. 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example filtering circuitry 200, the example user presence analyzing circuitry 202, and the example report timing circuitry 204.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 632, which may be implemented by the machine readable instructions of FIG. 4, may be stored in the mass storage device 628, in the volatile memory 614, in the non-volatile memory 616, and/or on a removable non-transitory computer readable storage medium such as a CD or DVD.

FIG. 7 is a block diagram of an example processor platform 700 structured to execute and/or instantiate the machine readable instructions and/or the operations of FIG. 5 to implement the device control circuitry 152 of FIG. 3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes processor circuitry 712. The processor circuitry 612 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example user presence state identifying circuitry 302, the example device response management circuitry 304, and the example device control timing circuitry 306.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 732, which may be implemented by the machine readable instructions of FIG. 5, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 612 of FIG. 6 and/or the processor circuitry 712 of FIG. 7. In this example, the processor circuitry 612 of FIG. 6 and/or the processor circuitry 712 of FIG. 7 is implemented by a general purpose microprocessor 800. The general purpose microprocessor circuitry 800 executes some or all of the machine readable instructions of the flowcharts of FIGS. 4 and/or 5 to effectively instantiate the circuitry of FIGS. 2 and/or 3 as logic circuits to perform the operations corresponding to those machine readable instructions. In some such examples, the circuitry of FIGS. 2 and/or 3 is instantiated by the hardware circuits of the microprocessor 800 in combination with the instructions. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4 and/or 5.

The cores 802 may communicate by a first example bus 804. In some examples, the first bus 804 may implement a communication bus to effectuate communication associated with one(s) of the cores 802. For example, the first bus 804 may implement at least one of an Inter-Integrated Circuit (I2C) bus, a Serial Peripheral Interface (SPI) bus, a PCI bus, or a PCIe bus. Additionally or alternatively, the first bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 614, 616 of FIG. 6 and/or the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 612 of FIG. 6 and/or the processor circuitry 712 of FIG. 7. In this example, the processor circuitry 612, 712 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 4 and/or 5 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 4 and/or 5. In particular, the FPGA_00 may be thought of as an array of logic gates, interconnections, and switches. The switches can be programmed to change how the logic gates are interconnected by the interconnections, effectively forming one or more dedicated logic circuits (unless and until the FPGA circuitry_00 is reprogrammed). The configured logic circuits enable the logic gates to cooperate in different ways to perform different operations on data received by input circuitry. Those operations may correspond to some or all of the software represented by the flowcharts of FIGS. 4 and/or 5. As such, the FPGA circuitry 900 may be structured to effectively instantiate some or all of the machine readable instructions of the flowcharts of FIGS. 4 and/or 5 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 4 and/or 5 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may implement the microprocessor 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 4 and/or 5 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 612 of FIG. 6 and/or the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 612 of FIG. 6 and/or the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 4 and/or 5 may be executed by one or more of the cores 802 of FIG. 8, a second portion of the machine readable instructions represented by the flowcharts of FIGS. 4 and/or 5 may be executed by the FPGA circuitry 800 of FIG. 8, and/or a third portion of the machine readable instructions represented by the flowcharts of FIGS. 4 and/or 5 may be executed by an ASIC. It should be understood that some or all of the circuitry of FIGS. 2 and/or 3 may, thus, be instantiated at the same or different times. Some or all of the circuitry may be instantiated, for example, in one or more threads executing concurrently and/or in series. Moreover, in some examples, some or all of the circuitry of FIGS. 2 and/or 3 may be implemented within one or more virtual machines and/or containers executing on the microprocessor.

In some examples, the processor circuitry 612 of FIG. 6 and/or the processor circuitry 712 of FIG. 7 may be in one or more packages. For example, the processor circuitry 800 of FIG. 8 and/or the FPGA circuitry 900 of FIG. 9 may be in one or more packages. In some examples, an XPU may be implemented by the processor circuitry 612 of FIG. 6 and/or the processor circuitry 712 of FIG. 7, which may be in one or more packages. For example, the XPU may include a CPU in one package, a DSP in another package, a GPU in yet another package, and an FPGA in still yet another package.

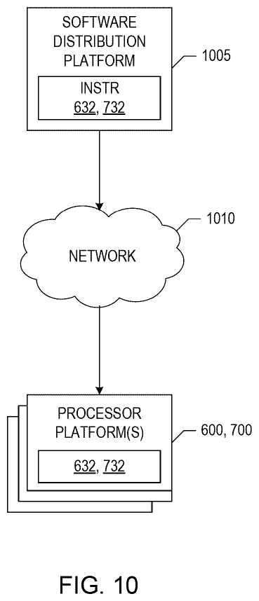

A block diagram illustrating an example software distribution platform 1005 to distribute software such as the example machine readable instructions 632 of FIG. 6 and/or the example machine readable instructions 632 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 632 of FIG. 6 and/or the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 632, which may correspond to the example machine readable instructions 400 of FIG. 4, and/or the machine readable instructions 732, which may correspond to the example machine readable instructions 500 of FIG. 5, as described above. The one or more servers of the example software distribution platform 1005 are in communication with a network 1010, which may correspond to any one or more of the Internet and/or any of the example networks 626, 726 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632, 732 from the software distribution platform 1005. For example, the software, which may correspond to the example machine readable instructions 400 of FIG. 4, may be downloaded to the example processor platform 600, which is to execute the machine readable instructions 632 to implement the subject detection circuitry 140. The software, which may correspond to the example machine readable instructions 500 of FIG. 5, may be downloaded to the example processor platform 700, which is to execute the machine readable instructions 732 to implement the device control circuitry 152. In some example, one or more servers of the software distribution platform 1005 periodically offer, transmit, and/or force updates to the software (e.g., the example machine readable instructions 632 of FIG. 6, the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that manage states (e.g., lock states, power states) of an electronic user device (e.g., a PC, a tablet, etc.) based on user presence relative to a peripheral input device (e.g., a mouse, a keyboard, a video camera) in communication with the user device. Examples disclosed herein identify a presence or absence of user(s) relative to the peripheral input device based on sensor data generated by user presence detection sensors (e.g., time-of-flight sensors) carried by the peripheral input device. In response to the user presence states (e.g., present state, absent state) identified with respect to the peripheral input device, examples disclosed herein transition the user device between, for instance, a connected standby mode and a fully operational power state mode. Examples disclosed herein control the device states (e.g., wake the device) prior to a user providing inputs via the user device and/or the peripheral input device. Examples disclosed herein enable user presence states to be detected via peripheral input devices, which can reduce costs and efforts that would otherwise be incurred in upgrading electronic user devices to provide for user presence detection.

Example peripheral input devices including user presence detection sensors and related methods are disclosed herein. Further examples and combinations thereof include the following:
Example 1 includes an apparatus comprising memory; instructions; and processor circuitry to execute the instructions to cause an electronic user device to transition from a first device state to a second device state in response to an indication of a first user presence state at a first time, the first user presence state relative to a peripheral input device communicatively coupled to the electronic user device; cause the electronic user device to transition from the second device state to a third device state in response to an indication of a second user presence state relative to the peripheral input device at a second time, the second time different than the first time; and cause the electronic user device to transition from the third device state to the first device state in response to an indication of the second user presence state relative to the peripheral input device at a third time, the third time different than the first time and the second time.
Example 2 includes the apparatus of example 1, wherein the first device state includes a first power state, the second device state includes a second power state, the second power state associated with greater power than the first power state, and the third device state includes a locked state.
Example 3 includes the apparatus of examples 1 or 2, wherein the first user presence state is a present state and the second user presence state is an absent state.
Example 4 includes the apparatus of any of examples 1-3, wherein the processor circuitry is to cause the electronic user device to transition from the second device state to the third device state in response to a first threshold of time being satisfied.
Example 5 includes the apparatus of any of examples 1-4, wherein the processor circuitry is to cause the electronic user device to move from the third device state to the first device state in response to a second threshold of time being satisfied.
Example 6 includes the apparatus of any of examples 1-5, wherein the processor circuitry is to cause a brightness of a display screen of the electronic user device to be adjusted prior to causing the electronic user device to transition from the second device state to the third device state.
Example 7 includes the apparatus of any of examples 1-6, wherein the processor circuitry is to detect a user presence state as the first user presence state at a fourth time, the fourth time between the first time and the second time, the processor circuitry to maintain the electronic user device in the second device state in response to the first user presence state at the fourth time.
Example 8 includes at least one non-transitory computer readable medium comprising instructions which, when executed, cause one or more processors of a computing device to at least identify a user presence state as a first user presence state at a first time based on a first user presence state report associated with a peripheral input device, the first user presence state relative to the peripheral input device, the peripherical input device communicatively coupled to the computing device; and identify the user presence state as a second user presence state relative to the peripheral input device at a second time based on a second user presence state report, the second time different than the first time; identify the user presence state as the second user presence state relative to the peripheral input device at a third time based on a third user presence state report, the third time different than the first time and the second time; cause the computing device to transition from a first device state to a second device state in response to the identification of the first user presence state at the first time; cause the computing device to transition from the second device state to a third device state in response to the identification of the second user presence state at the second time; and cause the computing device to transition from the third device state to the first device state in response to the identification of the second user presence state at the third time.
Example 9 includes the at least one non-transitory computer readable medium of example 8, wherein the first device state includes a connected standby mode, the second device state includes a working power state, and the third device state includes a locked state.
Example 10 includes the at least one non-transitory computer readable medium of examples 8 or 9, wherein the first user presence state is a present state and the second user presence state is an absent state.
Example 11 includes the at least one non-transitory computer readable medium of any of examples 8-10, wherein the instructions, when executed, cause the one or more processors to cause the computing device to transition from the second device state to the third device state in response to a first threshold of time being satisfied.
Example 12 includes the at least one non-transitory computer readable medium of any of examples 8-11, wherein the instructions, when executed, cause the one or more processors to cause the computing device to move from the third device state to the first device state in response to a second threshold of time being satisfied.
Example 13 includes the at least one non-transitory computer readable medium of any of examples 8-12, wherein the instructions, when executed, cause the one or more processors to cause a brightness of a display screen of the computing device to be adjusted prior to causing the computing device to transition from the second device state to the third device state.
Example 14 includes the at least one non-transitory computer readable medium of any of examples 8-13, wherein the instructions, when executed, cause the one or more processors to identify the user presence state as the first user presence state at a fourth time, the fourth time between the first time and the second time; and maintain the computing device in the second device state in response to the first user presence state at the fourth time.
Example 15 includes a system comprising subject detection circuitry to identify a first user presence state relative to a peripheral input device based on sensor data corresponding to signals output by a sensor of the peripheral input device at a first time, the first user presence state indicative of an absence of a user relative to the peripheral input device; and detect a change from the first user presence state to a second user presence state relative to the peripheral input device based on sensor data corresponding to signals output by the sensor of the peripheral input device at a second time, the second time after the first time, the second user presence state indicative of a presence of the user relative to the peripheral input device; and device control circuitry to cause a power state an electronic user device in communication with the peripheral input device to move from a first power state to a second power state in response to the change from the first user presence state to the second user presence state, the second power state associated with greater power than the first power state.
Example 16 includes the system of example 15, wherein the sensor data includes time-of-flight measurement data.
Example 17 includes the system of examples 15 or 16, wherein the subject detection circuitry is to identify the first user presence state at a third time, the third time after the first time and the second time and the device control circuitry is to cause the electronic user device to move to a locked state in response to the user presence state being the first user presence state.
Example 18 includes the system of any of examples 15-17, wherein the device control circuitry is to cause the electronic user device to move to the locked state in response a threshold of time being satisfied.
Example 19 includes the system of any of examples 15-18, wherein the device control circuitry is to cause the electronic user device to move from the locked state to the low power state in response to the user presence state being the first user presence state at a fourth time, the fourth time occurring after the third time.
Example 20 includes the system of any of examples 15-19, wherein the device control circuitry is to cause a display screen of the electronic user device to dim prior to moving to the locked state and in response to the user presence state being the first user presence state.
Example 21 includes a peripheral input device comprising a sensor; memory; instructions; and processor circuitry to execute the instructions to detect a first user presence state relative to the peripheral input device based on signals output by the sensor at a first time; transmit the first user presence state to a user device in communication with the peripheral input device to cause the user device to move the user device from a first power state to a second power state; detect a second user presence state relative to the peripheral input device based on signals output by the sensor at a second time, the second time different than the first time; and transmit the second user presence state to the user device to cause the user device to one of maintain the second power state or move from the second power state to the first power state.
Example 22 includes the peripheral input device of example 21, wherein the peripheral input device is a mouse.
Example 23 includes the peripheral input device of examples 21 or 22, wherein the sensor is a time-of-flight sensor.
Example 24 includes the peripheral input device of any of examples 21-23, wherein the processor circuitry is to transmit one or more of the first user presence state or the second user presence state to the user device at periodic intervals.
Example 25 includes the peripheral input device of any of examples 21-24, wherein the processor circuitry is to transmit the second user presence state based on a time threshold for transmitting the second user presence state.
Example 26 includes an apparatus comprising means for identifying to identify a user presence state as a first user presence state at a first time based on a first user presence state report associated with a peripheral input device, the first user presence state relative to the peripheral input device, the peripherical input device communicatively coupled to an electronic user device; identify the user presence state as a second user presence state relative to the peripheral input device at a second time based on a second user presence state report, the second time different than the first time; and identify the user presence state as the second user presence state relative to the peripheral input device at a third time based on a third user presence state report, the third time different than the first time and the second time; and means for managing to cause the electronic user device to transition from a first device state to a second device state in response to the identification of the first user presence state at the first time; cause the electronic user device to transition from the second device state to a third device state in response to the identification of the second user presence state at the second time; and cause the electronic user device to transition from the third device state to the first device state in response to the identification of the second user presence state at the third time.
Example 27 includes the apparatus of example 26, wherein the first device state includes a standby mode, the second device state includes a working power state, and the third device state includes a locked state.
Example 28 includes the apparatus of examples 26 or 27, wherein the first user presence state is a present state and the second user presence state is an absent state.
Example 29 includes the apparatus of any of examples 26-28, further including means for device control timing to monitor respective times at which the identifying means identifies the first user presence state and the second user presence state.
Example 30 includes the apparatus of any of examples 26-29, wherein the managing means to cause the electronic user device to transition from the transition from the third device state to the first device state based on the monitoring by the device control timing means.
Example 31 includes the apparatus of any of examples 26-30, wherein the managing means is to output a report indicating that the electronic user device is in the first device state for transmission to the peripheral input device.
Example 32 includes an apparatus comprising interface circuitry to receive user presence state reports from a peripheral input device; and processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus; a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or Application Specific Integrate Circuitry (ASIC) including logic gate circuitry to perform one or more third operations; the processor circuitry to perform at least one of the first operations, the second operations, or the third operations to instantiate user presence state identifying circuitry to identify a user presence state as a first user presence state at a first time based on the user presence state reports, the first user presence state relative to the peripheral input device; and identify the user presence state as a second user presence state relative to the peripheral input device at a second time and a third time based on the user presence state reports, the second time different than the first time, the third time different than the first time and the second time; and device response management circuitry to cause a user device to transition from a first device state to a second device state in response to the identification of the first user presence state at the first time, the user device communicatively coupled to the peripheral input device; cause the user device to transition from the second device state to a third device state in response to the identification of the second user presence state at the second time; and cause the user device to transition from the third device state to the first device state in response to the identification of the second user presence state at the third time.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
memory;
machine-readable instructions; and
at least one processor circuit to be programmed by the machine-readable instructions to:
cause an electronic user device to transition from a first device state to a second device state in response to an indication of a first user presence state at a first time, the first user presence state relative to a peripheral input device communicatively coupled to the electronic user device;
cause the electronic user device to transition from the second device state to a third device state in response to an indication of a second user presence state relative to the peripheral input device at a second time, the second time different than the first time; and
cause the electronic user device to transition from the third device state to the first device state in response to an indication of the second user presence state relative to the peripheral input device at a third time, the third time different than the first time and the second time.

2. The apparatus of claim 1, wherein the first device state includes a first power state, the second device state includes a second power state, the second power state associated with greater power than the first power state, and the third device state includes a locked state.

3. The apparatus of claim 1, wherein the first user presence state is a present state and the second user presence state is an absent state.

4. The apparatus of claim 1, wherein one or more of the at least one processor circuit is to cause the electronic user device to transition from the second device state to the third device state in response to a first threshold of time being satisfied.

5. The apparatus of claim 4, wherein one or more of the at least one processor circuit is to cause the electronic user device to transition from the third device state to the first device state in response to a second threshold of time being satisfied.

6. The apparatus of claim 1, wherein one or more of the at least one processor circuit is to cause a brightness of a display screen of the electronic user device to be adjusted prior to causing the electronic user device to transition from the second device state to the third device state.

7. The apparatus of claim 1, wherein one or more of the at least one processor circuit is to:
detect a user presence state as the first user presence state at a fourth time, the fourth time between the first time and the second time; and
maintain the electronic user device in the second device state in response to the first user presence state at the fourth time.

8. At least one non-transitory computer readable medium comprising machine-readable instructions that cause at least one processor circuit of a computing device to at least:
identify a user presence state as a first user presence state at a first time based on a first user presence state report associated with a peripheral input device, the first user presence state relative to the peripheral input device, the peripherical input device communicatively coupled to the computing device;
identify the user presence state as a second user presence state relative to the peripheral input device at a second time based on a second user presence state report, the second time different than the first time;
identify the user presence state as the second user presence state relative to the peripheral input device at a third time based on a third user presence state report, the third time different than the first time and the second time;
cause the computing device to transition from a first device state to a second device state in response to the identification of the first user presence state at the first time;
cause the computing device to transition from the second device state to a third device state in response to the identification of the second user presence state at the second time; and
cause the computing device to transition from the third device state to the first device state in response to the identification of the second user presence state at the third time.

9. The at least one non-transitory computer readable medium of claim 8, wherein the first device state includes a connected standby mode, the second device state includes a working power state, and the third device state includes a locked state.

10. The at least one non-transitory computer readable medium of claim 8, wherein the first user presence state is a present state and the second user presence state is an absent state.

11. The at least one non-transitory computer readable medium of claim 8, wherein the machine-readable instructions are to cause one or more of the at least one processor circuit to cause the computing device to transition from the second device state to the third device state in response to a first threshold of time being satisfied.

12. The at least one non-transitory computer readable medium of claim 11, wherein the machine-readable instructions are to cause one or more of the at least one processor circuit to cause the computing device to transition from the third device state to the first device state in response to a second threshold of time being satisfied.

13. The at least one non-transitory computer readable medium of claim 8, wherein the machine-readable instructions are to cause one or more of the at least one processor circuit to cause a brightness of a display screen of the computing device to be adjusted prior to causing the computing device to transition from the second device state to the third device state.

14. The at least one non-transitory computer readable medium of claim 8, wherein the machine-readable instructions are to cause one or more of the at least one processor circuit to:
identify the user presence state as the first user presence state at a fourth time, the fourth time between the first time and the second time; and
maintain the computing device in the second device state in response to the first user presence state at the fourth time.

15. A system comprising:
interface circuitry:
machine-readable instructions; and
at least one processor circuit to be programmed by the machine-readable instructions to:
identify a first user presence state relative to a peripheral input device based on sensor data corresponding to signals output by a sensor of the peripheral input device at a first time, the first user presence state indicative of an absence of a user relative to the peripheral input device;
detect a change from the first user presence state to a second user presence state relative to the peripheral input device based on sensor data corresponding to signals output by the sensor of the peripheral input device at a second time, the second time after the first time, the second user presence state indicative of a presence of the user relative to the peripheral input device; and
cause a power state an electronic user device in communication with the peripheral input device to move from a first power state to a second power state in response to the change from the first user presence state to the second user presence state, the second power state associated with greater power than the first power state.

16. The system of claim 15, wherein the sensor data includes time-of-flight measurement data.

17. The system of claim 15, wherein the one or more of the at least one processor circuit is to:
identify the first user presence state at a third time, the third time after the first time and the second time; and
cause the electronic user device to move to a locked state in response to the user presence state being the first user presence state.

18. The system of claim 17, wherein the one or more of the at least one processor circuit is to cause the electronic user device to move to the locked state in response a threshold of time being satisfied.

19. The system of claim 17, wherein the one or more of the at least one processor circuit is to cause the electronic user device to move from the locked state to the first power state in response to the user presence state being the first user presence state at a fourth time, the fourth time occurring after the third time.

20. The system of claim 17, wherein the one or more of the at least one processor circuit is to cause a display screen of the electronic user device to dim prior to moving to the locked state and in response to the user presence state being the first user presence state.

21.-32. (canceled)
